(19) United States
(12) Patent Application Publication
(10) Pub. No.: US 2024/0367192 A1
(43) Pub. Date: Nov. 7, 2024

(54) ASSEMBLY FOR AND METHOD OF DISPENSING A LIQUID

(71) Applicant: Fast & Fluid Managment B.V., Sassenheim (NL)

(72) Inventors: Johannes Hermanus Nicolaas Post, Sassenheim (NL); Marcel Engels, Voorhout (NL); Peter Ronald Krom, Katwijk (NL)

(73) Assignee: Fast & Fluid Managment B.V., Sassenheim, KZ (NL)

(21) Appl. No.: 18/775,231

(22) Filed: Jul. 17, 2024

Related U.S. Application Data
(63) Continuation of application No. 15/510,830, filed on Mar. 13, 2017, now Pat. No. 12,070,765.

(30) Foreign Application Priority Data
Sep. 17, 2014 (EP) 14185202.0

(51) Int. Cl. B05B 15/531; B01F 25/50; B01F 33/841; B01F 35/12; B01F 35/21; B01F 35/75; B01F 35/88; B01F 101/30

(52) U.S. Cl. CPC B05B 15/531; B01F 25/50; B01F 33/841; B01F 35/122; B01F 35/2136; B01F 35/7544; B01F 35/7547; B01F 35/8822; B01F 2101/30

(57) ABSTRACT

Assembly for dispensing a liquid, in particular a colorant for paint, comprising a container for holding a liquid, a pump, a valve, at least one dispense opening, and comprising or associated with a controller arranged to operate the pump and the valve to withdraw liquid from the container and to dispense liquid via the opening and to operate the pump and the valve to purge liquid from the pump to the container via the dispense opening.

### CROSS-REFERENCE TO RELATED APPLICATION(S)

This application is a continuation application of U.S. Ser. No. 15/510,830, entitled Assembly for and Method of Dispensing a Liquid, filed Mar. 13, 2017, which is a national stage entry of PCT Application No. PCT/EP2015/071375, filed Sep. 17, 2015, which claims priority to European Patent Application No. 14185202.0, filed Sep. 17, 2014, all of which are incorporated herein by reference.

### BACKGROUND

The invention relates to an assembly for and a method of dispensing a liquid, in particular a colorant for paint.

EP 1 492 970 relates to a valve assembly for a fluid dispenser, which includes a housing having at least a first opening and a second opening, a valve member fitted in the housing, the valve member being rotatable about an axis and comprising a first channel, extending along said axis and communicating with the first opening in the housing, and at least two outlet channels radially extending from the first channel to the circumference of the valve member, wherein each of the radially extending outlet channels can be brought in register with the second opening by rotating the valve member.

EP 1 688 652 relates to a similar valve assembly, wherein at least one of said housing and said valve member is made of a synthetic material and the assembly further comprises a spring, which urges the valve member towards or onto an inner wall of the housing.

U.S. Pat. No. 2,985,339 relates to a dispenser for metering predetermined quantities comprising a valve member (indicated by numeral 36 in the Figures of U.S. Pat. No. 2,985,339). valve member 36, in the normal rest position illustrated in FIG. 6, has recess 36a in its outer cylindrical surface opposite discharge opening 35 valve member 36 has two radial valve passages 54 and at right angles to each other and intersecting at the axis of the valve member.”

US 2012/250451 relates to a method of homogenizing a liquid, in particular a colorant for paint, in a container, comprising the steps of withdrawing liquid from the container at a first flow speed (S1) and then returning the liquid to the container at a second flow speed (S2), higher than the first flow speed (S1).

For example, colorant dispensers for paint, purging, i.e., dispensing a small amount of colorant to clean the dispense opening and thus reduce the risk of so-called mistints resulting from nozzle blockage, for example, caused by colorant drying in the dispense opening, is a common and effective practice. However, purging implies waste of colorant.

It is an object of the present invention to provide effective cleaning of the dispense opening and yet reduce or prevent such waste.

### SUMMARY

The invention relates to an assembly comprising a container for holding a liquid, a pump, a valve, at least one dispense opening, i.e. an opening that, at least during dispensing, communicates with the outside of the pump to dispense liquid from the assembly and into, for example, a receptacle, and comprises or is associated with a controller arranged to operate the pump and the valve to withdraw liquid from the container, to dispense liquid via the opening and to operate the pump and the valve to purge liquid from the pump to the container via the dispense opening.

In an embodiment, the assembly comprises at least one further dispense opening, for example, having a diameter different from the diameter of the first dispense opening, for example, smaller to allow more accurate dispensing or larger to allow faster dispensing, and wherein the controller is arranged to operate the pump and the valve to purge liquid from the pump to the container via the at least one further dispense opening, preferably via all dispense openings in succession. In another embodiment, the valve, in a first position, connects the container to the pump and, in a second or further position, connects the pump to the or a dispense opening.

In a further embodiment, the valve comprises a rotatable valve member (e.g., a valve ball, cylinder or disc), and the dispense opening(s) is (are respectively) defined in the valve member (e.g., as a channel or channels that extends respectively extend radially or axially in the valve member). Thus, the liquid is dispensed directly from the valve member, for example, through a larger opening in the valve, such as in the housing of the valve, preferably preventing the liquid from contacting the larger opening.

With the present invention the dispense opening can be cleaned by the purging with colorant itself and yet, because the purged colorant is returned to the container, waste is reduced or prevented altogether.

In a refinement, the openings are all located within 120°, preferably within 110°, of rotation of the valve member from each other. Thus, total rotation required to purge all openings is limited and operation facilitated.

The controller can be integrated with the other parts of in the assembly or, for example, associated with the other parts, such as positioned at a dispense position and coupled with the other parts when these are at the dispense position.

In a further embodiment, which can be used outside the context of purging as described above, in a position of the valve, at least the pump is closed and the controller is arranged to establish, preferably by measuring the compressibility or expandability of the medium, for example, by measuring resistance in or stroke of the pump, whether and, if so, to what extent the medium contains air. In a refinement, in a position of the valve, all suction and dispense openings and routes are closed.

If the liquid inside the pump allows more compression or expansion than the liquid as such, this is an indication that the liquid contains air. The liquid may contain air as a result of, for example, production or mixing of the liquid or of an empty container, refilling of a container, or a leaking seal in the assembly. The degree of displacement provides an indication of the root cause. Pump condition and/or container filling status can be registered and communicated to the operator and/or service representative, for example, by means of signals and/or a log.

In a further embodiment, the valve comprises a variable opening and/or a plurality of different openings and the controller is arranged to establish whether flow resistance in the liquid over the opening. This can be achieved, for example, by accurately controlling the valve and/or shaping the openings, for example, oval, diamond or oblong, to vary overlap between internal openings and/or providing two or more channels having different diameters and/or different effective cross-sections and thus set flow resistance.

This provides a means for determining the condition of the liquid, for example, by measuring flow resistance from the control of motor driving the pump, for example, at different openings or overlaps. Overlap and/or shape and/or surface and/or length (in flow direction) of the opening will affect the shear in the liquid and for example, for shear thinning and/or shear thickening liquids this will provide information whether a certain viscosity yield value is still present, which can serve as an indication of the condition of the liquid.

Measurements of (parameters indicative of) compressibility, expandability or flow resistance can be performed automatically, for example, periodically and/or outside business hours, and a signal generated to inform an operator or service representative.

In another embodiment, the controller is arranged to purge the dispense opening(s) and perform said measurements automatically, for example, periodically and/or outside business hours.

In a further embodiment, the pump is a positive displacement pump, preferably a reciprocating pump, preferably a piston pump.

The invention further relates to a method of dispensing a liquid, in particular a colorant for paint, from an assembly comprising a container holding a liquid, a pump, a valve, and at least one dispense opening, comprising the steps of withdrawing liquid from the container and dispense the liquid from the dispense opening, and characterized by purging liquid from the pump to the container via the dispense opening.

In an embodiment, the assembly comprises a further dispense opening and wherein liquid is purged from the pump to the container via the further dispense opening.

In another embodiment, the pump is closed by means of the valve and the degree of compressibility or expandability of the liquid in the pump is established.

In a further embodiment comprises varying an opening, for example, between the pump and the container, generating a flow of the liquid through different openings and establishing flow resistance in the liquid over the different openings.

Within the framework of the present invention the term “liquid” is defined as any flowable material that comprises a liquid phase and thus includes suspensions and emulsions. Colorants often contain high density pigments or particles suspended in (instable) liquid binder/solvent solutions.

### BRIEF DESCRIPTION OF THE DRAWINGS

The disclosed invention will be further explained with reference to the accompanying drawings in which presently preferred embodiments of the invention are shown schematically.

FIG. 1 is a perspective view of a part of a disclosed apparatus for dispensing viscous liquid.

FIG. 2 is cross-sectional side view of a disclosed valve assembly suitable for use in the apparatus of FIG. 1.

FIG. 3 is a partial detailed view of the valve assembly of FIG. 2.

FIG. 4 is a cross-sectional front view of the valve assembly as shown in FIG. 3.

FIGS. 5A and 5B show the same detail as FIG. 3 at different positions of the valve.

FIG. 6 shows part of a further embodiment comprising a different valve at seven positions.

### DETAILED DESCRIPTION

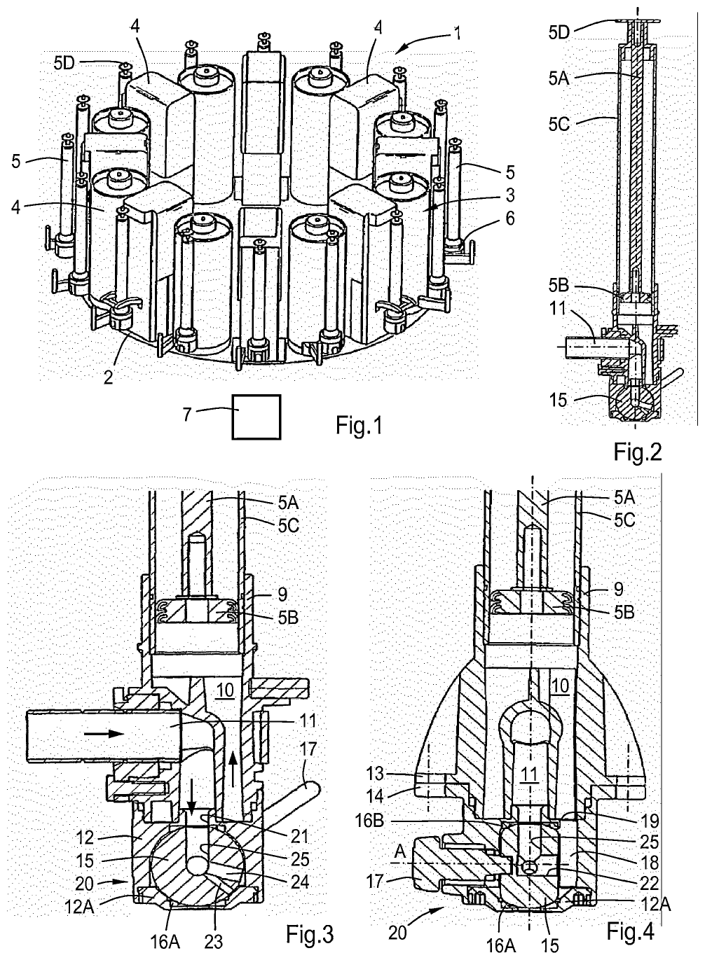

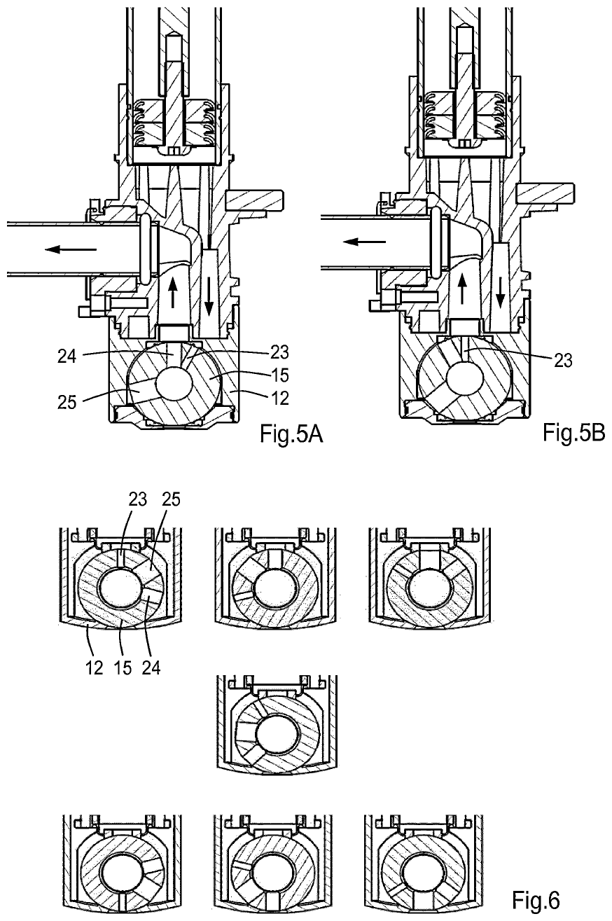

FIG. 1 illustrates the main parts of an example of an apparatus 1 for dispensing viscous liquids, such as colorants or dyes. This particular dispensing apparatus includes a turntable 2 rotatable about a vertical axis by means of a drive (not shown) in order to rotate the turntable 2 between discrete positions. On the turntable 2, there are mounted a plurality of assemblies 3, each comprising a container 4 for holding a liquid, pump 5, and a valve 6. Further details of the said apparatus and turntable are disclosed in U.S. Pat. No. 6,273,298, the contents of which are incorporated herein by reference.

FIGS. 2 to 4 show cross-sections of the pump 5 and valve 6. The pump 5 is a piston pump and includes a piston rod SA provided with a piston SB, disposed within a cylinder SC of the pump 5, and an upper flange SD. The flange SD can be engaged by a controller 7 comprising an actuator (not shown) adapted to move the piston rod SA and the piston SB upwards during an intake stroke and downwards during a dispense stroke and an actuator (not shown) to operate the valve 6.

The controller 7 and actuators are stationary and arranged to position one of the assemblies 3 in line with the actuators in order to enable actuating the pump 5 and the valve 6. The cylinder SC is mounted in the top part of a pump housing 9, which defines a cavity 10 and further includes an inlet channel 11 that is separated from the cavity 10 and adapted to be in fluid communication with a container 4 as shown in FIG. 1.

A valve housing 12, comprising a cover 12A, is attached to the lower part of the pump housing 9 by means of respective flanges 13, 14. A valve member, in this example a ball 15, is fitted in the housing 12 by means of two annular bearings 16A, 16B made of, for example, a polymeric material, such as PTFE (Teflon). The valve member 15 is provided with a lever 17 with which it can be rotated about an axis A by means of the corresponding actuator. The valve housing 12 further defines a cavity 18 limited at its upper part by a first opening 19, through which the cavity 18 communicates with the cavity 10 of the pump housing 9. The valve housing 12 further includes a second opening 20 in its bottom part and a third opening 21 which communicates with the inlet channel 11 in the pump housing 9. second opening 20 in its bottom part and a third opening 21 which communicates with the inlet channel 11 in the pump housing 9. The valve member 15 includes a first channel 22, extending along the axis A and communicating with the first opening 19 in the housing 12. It further includes at least two dispense openings, in this example in the form of outlet channels 23, 24, and an inlet channel 25, all radially extending from the first channel 22 to the circumference of the valve member 15. In this particular embodiment, the diameter of one of the outlet channels 23 is smaller than that of the other and the diameter of both outlet channels 23, 24 is smaller than that of the inlet channel 25. Further, both of these diameters are smaller than the diameter of the outlet opening in the housing 12 and the central axes of channels 23-25 are all located on the same sectional plane through the valve member 15 and are respectively, for example, 30° C. and 100° C. apart.

FIGS. 2 to 4 show the intake position of the valve member, where the inlet channel 25 of the valve member 15 is in registry with the third opening 21 of the valve housing 12 and thus with the inlet channel 11. In other words, the container communicates with the cavity 10 in the pump housing 9 and the cylinder 7. In this position, the cavity 10 and cylinder 7 now can be filled with a desired amount of the liquid from the container by moving the piston 6 upwards over a desired or predetermined length. It is noted that, in this position, the inlet channel 22 temporarily serves as an outlet channel.

As soon as an appropriate amount of liquid is taken in, the valve member 15 can be rotated to the desired dispensing position, i.e., until the desired dispense channel 23, 24 is in register with the opening 20 in the housing and the piston 6 can be moved downwards to dispense a desired or predetermined amount from the said opening 20. If this amount of liquid is relatively small and/or the dosage should be precise, the relatively narrow output channel 23 is appropriate and, if this amount is relatively large and/or should be dispensed rapidly, the relatively wide output channel 24 is appropriate. Thus, the valve assembly enables the tailored and, if need be, precise and/or rapid dispensing of viscous liquids, without having to exchange the valve assembly or components of the valve assembly.

During purging, shown in Figures SA and SB, the valve member 15 is rotated until the desired dispense channel—the larger diameter channel in Figure SA and the smaller diameter channel in Figure SB—to be purged is in register with the third opening 22 in the housing 12, which communicates with container 4. In these positions, the piston 6 is moved downwards to purge a predetermined amount of liquid through the dispense channel back to the container 4. FIG. 6 shows a further embodiment of a valve according to the present invention in seven positions. In this embodiment, the radial dispense channels 23, 24 are 1080 apart and the intake channel 25 is positioned in between the dispense channels. The positions are, in succession, intake or return of liquid via the intake channel 25, purging the larger diameter dispense channel 24 by returning liquid to the container, purging the smaller diameter dispense channel 23 by returning liquid to the container, closing the pump from all suction and dispense openings and routes fluid, dispensing via the smaller diameter dispense channel 23, dispensing via the larger diameter dispense channel 24, and dispensing via the intake channel 25.

As a matter of course, the invention is not restricted to the above-disclosed embodiment and can be varied in numerous ways within the scope of the claims.

What is claimed is:

1. An apparatus for dispensing a plurality of liquids, the apparatus comprising a plurality of dispenser assemblies comprising:
a container;
a pump;
a valve having a valve housing and a valve member in the valve housing, the valve member comprising an inlet channel and a dispense channel; and
a controller arranged to operate the pump and the valve of a selected one of the dispenser assemblies to move the valve member into:
an intake position connecting the container to the pump via the inlet channel to withdraw liquid from the container to the pump via the inlet channel;
a dispense position connecting the pump to a dispense opening in a bottom part of the valve housing via the dispense channel to dispense liquid from the pump via the dispense channel; and
a purge position connecting the pump to the container via the dispense channel and to purge liquid from the pump to the container via the dispense channel.

2. The apparatus of claim 1, further comprising at least one further dispense channel having a diameter different from the diameter of the first dispense channel, wherein the controller is arranged to operate the pump and the valve to purge liquid from the pump to the container sequentially via the first and further dispense channels.

3. The apparatus of claim 1, wherein the valve member is a rotatable valve member and the dispense channels and the inlet channel are radial channels.

4. The apparatus of claim 3, wherein the dispense channels are all located within 120 degrees of rotation of the valve member from each other.

5. The apparatus of claim 1, wherein the controller is arranged to move the valve into a closing position, to close at least the pump, the inlet channel and the dispense channels.

6. The apparatus of claim 5, wherein the controller is arranged to establish whether the medium inside the pump is compressible or expandable, while the valve is in the closing position.

7. The apparatus of claim 1, wherein the valve housing comprises a pump inlet opening communicating with a pump inlet channel of the pump.

8. The apparatus of claim 7, wherein the pump inlet opening of the valve housing and the dispense opening of the valve housing are at diametrically opposite sides of the valve member.

9. The apparatus of claim 7, wherein the inlet channel and the dispense channels of the valve member and the pump inlet opening and the dispense opening of the valve housing are arranged such that the dispense opening is closed when the pump inlet opening communicates with the inlet channel of the valve or with the first or further dispense channels of the valve and the pump inlet opening is closed when the dispense opening of the valve housing communicates with the inlet channel of the valve or with the first or further dispense channels of the valve.

10. The apparatus of claim 7, wherein the inlet channel and the dispense channels of the valve member and the pump inlet opening and the dispense opening of the valve housing are arranged such that when a selected one of the first or further dispense channels communicates with the pump inlet opening, the other ones of the first or further dispense channels and the inlet channel are closed.

11. The apparatus of claim 1, wherein the controller is arranged to establish flow resistance in the liquid over the dispense channels.

12. The apparatus of claim 11, wherein the dispense channels include a variable opening.

13. The assembly of claim 1, wherein the pump is a positive displacement pump.

14. The apparatus of claim 13, wherein the positive displacement pump is a piston pump.

15. An apparatus for dispensing a plurality of liquids, the apparatus comprising a plurality of dispenser assemblies comprising:
a container,
a pump;
a valve comprising:
a valve housing comprising a dispense opening in a bottom of the valve housing and a pump inlet opening communicating with a pump inlet channel of the pump; and
a rotatable valve member in the valve housing between the pump inlet opening and the dispense opening, the valve member comprising an inlet channel, a first dispense channel and at least one further dispense channel having a diameter different from the diameter of the first dispense channel, wherein the first and further dispense channels are radial channels within 120 degrees of rotation of the valve member from each other;
wherein the apparatus further comprises a controller arranged to operate the pump and the valve of a selected one of the dispenser assemblies to rotate the valve member into:
an intake position aligning the inlet channel of the valve member with the pump inlet opening to withdraw liquid from the container to the pump;
a dispense position for each one of the first or further dispense channels, aligning the respective dispense channel with the dispense opening in the bottom part of the valve housing to allow dispensing of liquid from the pump via the respective dispense channel; and
a purge position for each one of the first or further dispense channels connecting the pump to the container via the respective dispense channel and to purge liquid from the pump to the container via the respective dispense channel, while the inlet channel is closed; and
wherein the controller is arranged to purge the first and further dispense channels sequentially.

16. An apparatus for dispensing a plurality of liquids, the apparatus comprising a plurality of dispenser assemblies comprising:
a container;
a pump;
a valve comprising:
a valve housing comprising a dispense opening in a bottom of the valve housing and a pump inlet opening communicating with a pump inlet channel of the pump; and
a valve member in the valve housing between the pump inlet opening and the dispense opening, the valve member comprising an inlet channel, a first dispense channel and at least one further dispense channel;
wherein the apparatus further comprises a controller arranged to operate the pump and the valve of a selected one of the dispenser assemblies to move the valve member into:
an intake position aligning the inlet channel of the valve member with the pump inlet opening to withdraw liquid from the container to the pump;
a dispense position for each one of the first or further dispense channels, aligning the respective dispense channel with the dispense opening in the bottom part of the valve housing to allow dispensing of liquid from the pump via the respective dispense channel;
a purge position for each one of the first or further dispense channels connecting the pump to the container via the respective dispense channel and to purge liquid from the pump to the container via the respective dispense channel, while the inlet channel is closed; and
a closing position closing the pump, the inlet channel and the dispense channels; and
wherein the controller is arranged to establish whether liquid inside the pump is compressible, while the valve is in the closing position.

17. The apparatus of claim 16, wherein the inlet channel and the dispense channels of the valve member and the pump inlet opening and the dispense opening of the valve housing are arranged such that the dispense opening is closed when the pump inlet opening communicates with the inlet channel of the valve or with the first or further dispense channels of the valve and the pump inlet opening is closed when the dispense opening of the valve housing communicates with the inlet channel of the valve or with the first or further dispense channels of the valve.

18. The apparatus of claim 17, wherein the valve member is rotatable between the intake position, the closing position and the respective dispense positions and purging positions, and wherein the first and further dispense channels are radial channels within 120 degrees of rotation of the valve member from each other.

19. The apparatus of claim 18, wherein the inlet channel and the dispense channels of the valve member and the pump inlet opening and the dispense opening of the valve housing are arranged such that when a selected one of the first or further dispense channels communicates with the pump inlet opening, the other ones of the first or further dispense channels and the inlet channel are closed.

20. The apparatus of claim 16, wherein the controller is configured to establish flow resistance in the liquid over the dispense channels, and/or to establish whether the medium inside the pump is expandable while the valve is in the closing position.
